(19) United States
(12) Patent Application Publication
(10) Pub. No.: US 2018/0030379 A1
(43) Pub. Date: Feb. 1, 2018

(54) STRUCTURED FABRIC CARE COMPOSITIONS

(71) Applicant: The Procter & Gamble Company, Cincinnati, OH (US)

(72) Inventors: Susana FERNANDEZ-PRIETO, Benicarlo (ES); Neil Joseph LANT, NEWCASTLE UPON TYNE (GB); Pieter Jan Maria SAVEYN, HEUSDEN (DESTELBERGEN) (BE); Vincenzo GUIDA, WOLUWE SAINT PIERRE (BE)

(21) Appl. No.: 15/727,648

(22) Filed: Oct. 9, 2017

Related U.S. Application Data
(63) Continuation of application No. 14/327,608, filed on Jul. 10, 2014.

(30) Foreign Application Priority Data
Dec. 7, 2013 (EP) 13176347.6

(51) Int. Cl. C11D 3/00; C11D 3/22; C11D 1/62

(52) U.S. Cl. CPC C11D 3/0015; C11D 3/222; C11D 1/62

(57) ABSTRACT

Microfibrillated cellulose, derived from vegetables or wood, can be used to provide a liquid fabric care composition which is easy to pour, is stable and deposits well onto treated fabric.

### FIELD OF THE INVENTION

The present invention relates to liquid fabric care compositions structured using microfibrillated cellulose.

### BACKGROUND OF THE INVENTION

Liquid fabric care compositions are used to provide such fabric care benefits as softness, ease of ironing, and prevention of static cling. Such liquid fabric care are typically added as a rinse additive, after the washing cycles has been completed. The liquid fabric care compositions comprise a fabric softener active, typically in the form of vesicles or similar structures.

In order to enhance the pour profile, it is desirable to incorporate an external structurant into such liquid fabric care compositions. However, external structurants, particularly polymeric external structurants, typically result in poor phase stability of the liquid fabric care compositions, for instance, due to depletion flocculation. The lack of stability is particularly acute at low temperatures and high temperatures, as well as temperature fluctuations. This is because external structurants typically induce the fabric softener active to coalesce or flocculate. Phase stability is particularly challenging to achieve, when co-actives such as silicones or even hydrophobic perfumes are present.

The performance benefit from using liquid fabric care compositions can be improved, by improving deposition of the fabric softener active, and any coactives. Moreover, the deposition of fabric softener actives and coactives can vary with wash conditions, such as the presence of anionic surfactant in the rinse solution.

As such, a need remains for an externally structured liquid fabric care composition which provides improved stability to changes in temperature. In addition, a need remains for a liquid fabric care composition which provides improved deposition of the fabric care actives and coactives.

Fabric care compositions comprising copolymers are known. A bacterial cellulose with a reticulated structure is known. Liquid compositions that are structured using citrus fibres are known. Processes for preparing liquid compositions that comprise microfibrous cellulose are known. Microfibrillated celluloses, and methods for preparing them, are also known.

### SUMMARY OF THE INVENTION

The present invention relates a liquid fabric care composition comprising: fabric softener active, and microfibrillated cellulose derived from vegetables or wood.

The present invention further relates to a process to manufacture a liquid composition comprising a surfactant and microfibrillated cellulose derived from vegetables or wood, the process comprising the steps of: providing a structuring premix comprising microfibrillated cellulose, derived from vegetables or wood; providing a fabric care premix comprising a fabric softener active; and incorporating the structuring premix into the liquid fabric care premix using high shear mixing.

### DETAILED DESCRIPTION OF THE INVENTION

Microfibrillated cellulose, derived from vegetables or wood, has been found to provide stable structured liquid fabric care compositions, even at low usage temperatures below 20° C. and high usage temperatures above 30° C.

Such microfibrillated cellulose are also compatible with a broad range of coactives which can be used in liquid fabric care compositions. Suitable actives include silicones, functionalised silicones, perfumes, microcapsules, and the like.

Liquid fabric care compositions, which are structured using microfibrillated cellulose derived from vegetables or wood, have a high low-shear viscosity. Thus, microfibrillated cellulose, derived from vegetables or wood, is also effective at suspending particulates or droplets in liquid compositions, including solid particulates such as perfume microcapsules, and the like, and liquid droplets such as perfume droplets, other oils, and the like.

As used herein, the term “situs” includes paper products, fabrics, garments, hard surfaces, hair and skin.

As used herein, Iodine Value is the number of grams of iodine absorbed per 100 grams of the sample material.

Unless otherwise noted, all component or composition levels are in reference to the active portion of that component or composition, and are exclusive of impurities, for example, residual solvents or by-products, which may be present in commercially available sources of such components or compositions.

As defined herein, “essentially free of” a component means that the component is present at a level of less that 15%, preferably less 10%, more preferably less than 5%, even more preferably less than 2% by weight of the respective premix or composition. Most preferably, “essentially free of” a component means that no amount of that component is present in the respective premix, or composition.

As defined herein, “stable” means that no visible phase separation is observed for a liquid composition kept at 25° C. for a period of at least two weeks, preferably at least four weeks, more preferably at least a month or even more preferably at least four months, as measured using the Floc Formation Test, described in USPA 2008/0263780 A1. The liquid fabric care compositions disclosed herein may have a stability (no visual separation) of at least 6 weeks, preferably from 1 month to 24 months, more preferably from 2 months to 22 months, even more preferably from 4 months to 20 months, most preferably from 6 months to 18 months.

All percentages, ratios and proportions used herein are by weight percent of the respective premix or composition, unless otherwise specified. All average values are calculated “by weight” of the respective premix, composition, or components thereof, unless otherwise expressly indicated.

Unless otherwise noted, all component, premix, or composition levels are in reference to the active portion of that component, premix, or composition, and are exclusive of impurities, for example, residual solvents or by-products, which may be present in commercially available sources of such components or compositions.

All measurements are performed at 25° C. unless otherwise specified.

Microfibrillated Cellulose Derived from Vegetables or Wood:

External structurants provide a structuring benefit independently from, or extrinsic from, any structuring effect of surfactants in the composition. For instance, the external structurant can impart a shear thinning viscosity profile to a liquid composition, independently from, or extrinsic from, any structuring effect of the detersive surfactants of the composition.

Microfibrillated cellulose, derived from vegetables or wood, has been found to be suitable for use as an external structurant, for liquids comprising at least one surfactant. In is also believed that such microfiber celluloses improve the deposition of fabric softener actives and coactives. Suitable vegetables, from which the microfibrillated cellulose can be derived, include: sugar beet, chicory root, potato, carrot, and the like. Preferred vegetables or wood can be selected from the group consisting of: sugar beet, chicory root, and mixtures thereof.

Vegetable and wood fibres comprise a higher proportion of insoluble fibre than fibres derived from fruits, including citrus fruits. Preferred microfibrillated cellulose are derived from vegetables and woods which comprise less than 10% soluble fibre as a percentage of total fibre.

Suitable processes for deriving microfibrillated cellulose from vegetables and wood include the process described in U.S. Pat. No. 5,964,983.

Microfibrillated cellulose (MFC), is a material composed of nanosized cellulose fibrils, typically having a high aspect ratio (ratio of length to cross dimension). Typical lateral dimensions are 1 to 100, or 5 to 20 nanometres, and longitudinal dimension is in a wide range from nanometres to several microns. For improved structuring, the microfibrillated cellulose preferably has an average aspect ratio (l/d) of from 50 to 200,000, more preferably from 100 to 10,000.

Sugar beet pulp (SBP) is a by-product from the beet sugar industry. On a dry weight basis, SBP typically contains 65-80% polysaccharides, consisting roughly of 40% cellulose, 30% hemicelluloses, and 30% pectin.

Chicory (Cichorium intybus L.) belongs to the Asteraceae family and is a biennial plant with many applications in the food industry: the dried and roasted roots are used for flavouring coffee; the young leaves can be added to salads and vegetable dishes, and chicory extracts are used for foods, beverages and the like. Chicory fibres, present in chicory root, are known to comprise pectine, cellulose, hemicelluloses, and inulin. Inulin is a polysaccharide which is composed of a chain of fructose units with a terminal glucose unit. Chicory roots are particularly preferred as a source of inulin, since they can be used for the production of inulin which comprises long glucose and fructose chains. Chicory fibres, used to make the microfibrillated cellulose, can be derived as a by-product during the extraction of inulin. After the extraction of the inulin, chicory fibres typically form much of the remaining residue.

The fibres derived from sugar beet pulp and chicory comprise hemicelluloses. Hemicelluloses typically have a structure which comprises a group of branched chain compounds with the main chain composed of alpha-1,5-linked 1-arabinose and the side chain by alpha-1,3-linked 1-arabinose. Besides arabinose and galactose, the hemicelluloses also contained xylose and glucose. Before use for structuring purposes, the fibres can be ezymatically treated to reduce branching.

Microfibrils, derived from vegetables or wood, include a large proportion of primary wall cellulose, also called parenchymal cell cellulose (PCC). It is believed that such microfibrils formed from such primary wall cellulose provide improved structuring. In addition, microfibrils in primary wall cellulose are deposited in a disorganized fashion, and are easy to dissociate and separate from the remaining cell residues via mechanical means.

Charged groups can also be introduced into the microfiber cellulose, for instance, via carboxymethylation, as described in Langmuir 24 (3), pages 784 to 795. Carboxymethylation results in highly charged microfibillated cellulose which is easier to liberate from the cell residues during making, and have modified structuring benefits.

The microfibrillated cellulose can be derived from vegetables or wood which has been pulped and undergone a mechanical treatment comprising a step of high intensity mixing in water, until the vegetable or wood has consequently absorbed at least 15 times its own dry weight of water, preferably at least 20 times its own dry weight, in order to swell it. It may be derived by an environmentally friendly process from a sugar beet or chicory root waste stream. This makes it more sustainable than prior art external structurants.

Furthermore, it requires no additional chemicals to aid its dispersal and it can be made as a structuring premix to allow process flexibility.

The process to make microfibrillated cellulose derived from vegetables or wood, particularly from sugar beet or chicory root, is also simpler and less expensive than that for bacterial cellulose.

Microfibrillated cellulose, derived from vegetables or wood, can be derived using any suitable process, such as the process described in U.S. Pat. No. 5,964,983. For instance, the raw material, such as sugar beet or chicory root, can first be pulped, before being partially hydrolysed, using either acid or basic hydrolysis, to extract the pectins and hemicelluloses. The solid residue can then be recovered from the suspension, and a second extraction under alkaline hydrolysis conditions can be carried out, before recovering the cellulosic material residue by separating the suspension after the second extraction. The one or more hydrolysis steps are typically done at a temperature of from 60° C. to 100° C., more typically at from 70° C. to 95° C., with at least one of the hydrolysis steps being preferably under basic conditions. Caustic soda, potash, and mixtures thereof, is typically used at a level of less than 9 wt %, more preferably from 1% to 6% by weight of the mixture, for basic hydrolysis. The residues are then typically washed and optionally bleached to reduce or remove colouration. The residue is then typically made into an aqueous suspension, usually comprising 2 to 10 wt % solid matter, which is then homogenised. Homogenisation can be done using any suitable equipment, and can be carried out by mixing or grinding or any other high mechanical shear operation, typically followed by passing the suspension through a small diameter orifice and preferably subjecting the suspension to a pressure drop of at least 20 MPa and to a high velocity shearing action followed by a high velocity decelerating impact.

Liquid compositions, comprising microfibrillated cellulose derived from vegetables or wood, are typically thixotropic, providing good suspension of particles and droplets, while easily flowing under shear. As a result, microfibrillated cellulose, derived from vegetables or wood, is a particularly suitable structurant for surfactant containing liquid compositions, since it stabilises suspended insoluble material in the liquid composition, while reducing phase separation, and being compatible with a wide variety of typical adjuncts, including enzymes. Moreover, such microfibrillated cellulose, derived from vegetables or wood, are believed to also improve deposition of actives, including perfumes, perfume microcapsules, and the like.

Liquid Fabric Care Compositions:

The liquid fabric care compositions of the present invention can comprise from 0.05 to 10 wt %, preferably from 0.1 to 5 wt %, more preferably from 0.15 to 2 wt % of the microfibrillated cellulose, derived from vegetables or wood.

As used herein, “liquid composition” refers to any composition comprising a liquid capable of wetting and treating a substrate, such as fabric or hard surface. Liquid compositions are more readily dispersible, and can more uniformly coat the surface to be treated, without the need to first dissolve the composition, as is the case with solid compositions. Liquid compositions can flow at 25° C., and include compositions that have an almost water like viscosity, but also include “gel” compositions that flow slowly and hold their shape for several seconds or even minutes.

A suitable liquid composition can include solids or gases in suitably subdivided form, but the overall composition excludes product forms which are non-liquid overall, such as tablets or granules. The liquid compositions preferably have densities in the range from of 0.9 to 1.3 grams per cubic centimetre, more preferably from 0.95 to 1.10 grams per cubic centimetre, at 21° C., excluding any solid additives but including any bubbles, if present.

In order to provide a pleasing pour profile, without leaving residues in the container or dispenser, the liquid fabric care composition preferably has a viscosity of less than 2000 cps, from 15 cps to 1000 cps, from 25 cps to 700 cps, from 25 cps to 600 cps, or from 50 cps to 200 cps, measured at the usage temperature or 21° C.

The liquid fabric care compositions of the present invention comprises a fabric softener active. The fabric softener active can be selected from the group consisting of di-tail fabric softener actives, mono-tail fabric softener actives, ion pair fabric softener actives and mixtures thereof.

Preferred fabric softener actives are selected from the group consisting of:
a) materials having Formula (1) below:

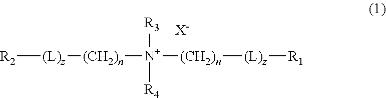

wherein:
   R₁ and R₂ are each independently a C₅-C₂₃ hydrocarbon, preferably C₁₁-C₁₇ hydrocarbon;
   R₃ and R₄ are each independently selected from the group consisting of C₁-C₄ hydrocarbon, C₁-C₄ hydroxy substituted hydrocarbon, benzyl, —(C₂H₄O)_{y}H where y is an integer from 1 to 10; preferably, R₃ and R₄ are each independently selected from the group consisting of C₁-C₂ hydrocarbon, C₁-C₂ hydroxy substituted hydrocarbon;
   L is selected from the group consisting of —C(O)O—, —(OCH₂CH₂)ₘ—, —(CH₂CH₂O)ₘ—, —C(O)—, —O—(O)C—, —NR—C(O)—, —C(O)—NR— wherein m is 1 or 2 and R is hydrogen or methyl; preferably, L is selected from the group consisting of —C(O)O—, —C(O)—, —O—(O)C—;
   each n is independently an integer from 0 to 4 with the proviso that when L is —C(O)O—, —O—(O)C—, —NR—C(O)—, or —C(O)—NR— the respective n is an integer from 1 to 4; preferably, each n is independently an integer from 1 to 2;
   each z is independently 0 or 1; and
   X⁻ is a softener-compatible anion, preferably selected from the group consisting of halides, sulfonates, sulfates, and nitrates, more preferably selected from the group consisting of chloride, bromide, methylsulfate, ethylsulfate, and methyl sulfonate;
b) materials having Formula (2) below:

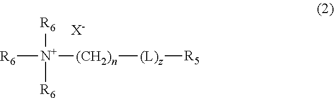

wherein:
   R₅ is a C₅-C₂₃ hydrocarbon, preferably C₁₁-C₁₇ hydrocarbon; each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10; preferably, each R₆ is independently selected from the group consisting of C₁-C₂ hydrocarbon, C₁-C₂ hydroxy substituted hydrocarbon;
   L is selected from the group consisting of —C(O)O—, —(OCH₂CH₂)ₘ— —(CH₂CH₂O)ₘ—, —C(O)—, —O—(O)C—, —NR—C(O)—, —C(O)—NR— wherein m is 1 or 2 and R is hydrogen or methyl;
   each n is independently an integer from 0 to 4 with the proviso that when L is ——C(O)O—, —O—(O)C—, —NR—C(O)—, or —C(O)—NR— the respective n is an integer from 1 to 4; preferably, n is an integer from 1 to 4;
   z is 0 or 1; and
   X⁻ is a softener-compatible anion, preferably selected from the group consisting of halides, sulfonates, sulfates, and nitrates, more preferably selected from the group consisting of chloride, bromide, methylsulfate, ethylsulfate, and methyl sulfonate;
c) materials having Formula (3) below:

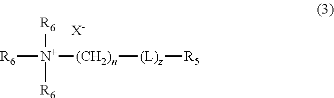

wherein:
   R₅ is a C₅-C₂₃ hydrocarbon, preferably a C₁₁-C₁₇ hydrocarbon;
   each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10; preferably, each R₆ is independently selected from the group consisting of C₁-C₂ hydrocarbon, C₁-C₂ hydroxy substituted hydrocarbon;
   L is selected from the group consisting of —C(O)O—, —(OCH₂CH₂)ₘ— —(CH₂CH₂O)ₘ—, —C(O)—, —O—(O)C—, —NR—C(O)—, —C(O)—NR— wherein m is 1 or 2 and R is hydrogen or methyl; preferably, L is selected from the group consisting of —C(O)O—, —C(O)—, —O—(O)C—;
   each n is independently an integer from 0 to 4 with the proviso that when L is —C(O)O—, —O—(O)C—, —NR—C(O)—, or —C(O)—NR— the respective n is an integer from 1 to 4; preferably, n is an integer from 1 to 4;
   z is 0 or 1; and
   X⁻ is an selected from the group consisting of chloride, bromide, methylsulfate, ethylsulfate, and methyl sulfonate or anionic surfactant comprising a C₆-C₂₄ hydrocarbon or C₆-C₁₈ hydrocarbon; if X⁻ is an anionic surfactant, the anionic surfactant is more preferably selected from the group consisting of a C₆-C₂₄ alkyl benzene sulfonate surfactant; a C₆-C₂₄ branched-chain and random alkyl sulfate surfactant; a C₆-C₂₄ alkyl alkoxy sulfate surfactant, having an average degree of alkoxylation of from 1 to 30, wherein the alkoxy moiety comprises a C₂ to C₄ chain; a mid-chain branched alkyl sulfate surfactant; a mid-chain branched alkyl alkoxy sulfate surfactant having an average degree of alkoxylation of from 1 to 30, wherein the alkoxy moiety comprises a C₂ to C₄ chain; a C₆-C₂₄ alkyl alkoxy carboxylates comprising an average degree of alkoxylation of from 1 to 5; a C₆-C₂₄ methyl ester sulfonate surfactant, a C₁₀-C₂₄ alpha-olefin sulfonate surfactant, a C₆-C₂₄ sulfosuccinate surfactant, and a mixture thereof;
d) a bis-(2-hydroxypropyl)-dimethylammonium methylsulphate fatty acid ester having a molar ratio of fatty acid moieties to amine moieties of from 1.85 to 1.99, an average chain length of the fatty acid moieties of from 16 to 18 carbon atoms and an iodine value of the fatty acid moieties, calculated for the free fatty acid, of from 0.5 to 60.

Alternatively, the fabric softening active (FSA) may be a mixture of more than one FSA.

The fabric softener active, used in the compositions of the present invention, may have Iodine Values (herein referred to as “IV”) of from 70 to 140. Alternatively, the IV range can be from zero to 70, or from 40 to 70. The fabric softener active can be made with fatty acid precursors with a range of IV from zero to 40.

The liquid fabric care composition may comprise, based on total composition weight, of at least 1%, preferably at least 2%, more preferably at least 5%, even more preferably at least 10%, most preferably at least 12% of said FSA or mixture of FSAs. The liquid fabric care composition may comprise, based on total composition weight, of less than 90%, preferably less than 40%, more preferably less than 30%, even more preferably less than 20%, most preferably less than 15% of said FSA or mixture of FSAs.

The liquid fabric care composition can comprise a pH modifier in an appropriate amount to make the fabric enhancer composition acidic. Preferably, the pH modifier is present at a level to provide the composition with a pH of less than 6, more preferably of from 2 to 5, most preferably from 2.5 to 4. If present, suitable levels of pH modifiers are less than 4% by weight of the composition, alternatively from 0.01% to 2% by weight. Suitable pH modifiers can be selected from the group consisting of: hydrogen chloride, citric acid, other organic or inorganic acids, and mixtures thereof.

The liquid fabric care composition can comprise one or more coactives. Suitable coactives can be selected from the group consisting silicone, functionalised silicone, perfume, microcapsules, and mixtures thereof. If present, the coactive is preferably selected from the group consisting silicone, functionalised silicone, particulates, and mixtures thereof. Preferred particulates include microcapsules, particularly perfume microcapsules.

Microfibrillated cellulose, derived from vegetables or wood, is particularly effective at stabilizing suspended insoluble material since it provides the liquid fabric care composition with a thixotropic rheology profile, and a yield stress which is sufficiently high enough to suspend such insoluble material. The composition preferably comprises sufficient microfibrillated cellulose to provide a yield stress of greater than 0.05 Pa, preferably 0.2 Pa. As such, the aqueous structuring premixes of the present invention are particularly suited for stabilizing liquid compositions which further comprise suspended insoluble material. Suitable suspended insoluble material can be selected from the group consisting of: particulates, insoluble fluids, and mixtures thereof. Suspended insoluble materials are those which have a solubility in the liquid composition of less than 1%, at a temperature of 21° C.

The particulates may be microcapsules such as perfume encapsulates, or care additives in encapsulated form. The particulates may alternatively, or additionally, take the form of insoluble ingredients such as quaternary ammonium materials, insoluble polymers, insoluble optical brighteners, enzymes, and other known benefit agents found, for example, in EP1328616. The amount of particulates may be from 0.001 to up to 10 or even 20 wt %.

Microcapsules are typically added to liquid fabric care compositions, in order to provide a long lasting in-use benefit to the treated substrate. Microcapsules can be added at a level of from 0.01% to 10%, more preferably from 0.1% to 2%, even more preferably from 0.15% to 0.75% of the encapsulated active, by weight of the liquid composition. In a preferred embodiment, the microcapsules are perfume microcapsules, in which the encapsulated active is a perfume. Such perfume microcapsules release the encapsulated perfume upon breakage, for instance, when the treated substrate is rubbed.

The term “microcapsule” is used herein in the broadest sense to include a core that is encapsulated by the microcapsule wall. In turn, the core comprises a benefit agent, such as a perfume. The microcapsules typically comprise a microcapsule core and a microcapsule wall that surrounds the microcapsule core. The microcapsule wall is typically formed by cross-linking formaldehyde with at least one other monomer.

The microcapsule core may optionally comprise a diluent. Diluents are material used to dilute the benefit agent that is to be encapsulated, and are hence preferably inert. That is, the diluent does not react with the benefit agent during making or use. Preferred diluents may be selected from the group consisting of: isopropylmyristate, propylene glycol, poly(ethylene glycol), or mixtures thereof.

Microcapsules, and methods of making them are disclosed in the following references: US 2003-215417 A1; US 2003-216488 A1; US 2003-158344 A1; US 2003-165692 A1; US 2004-071742 A1; US 2004-071746 A1; US 2004-072719 A1; US 2004-072720 A1; EP 1393706 A1; US 2003-203829 A1; US 2003-195133 A1; US 2004-087477 A1; US 2004-0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. Pat. No. RE 32,713; U.S. Pat. No. 4,234,627; US 2007-0275866 A1.

Encapsulation techniques are disclosed in MICROENCAPSULATION: Methods and Industrial Applications, Edited by Benita and Simon (Marcel Dekker, Inc., 1996). Formaldehyde based resins such as melamine-formaldehyde or urea-formaldehyde resins are especially attractive for perfume encapsulation due to their wide availability and reasonable cost.

The microcapsules preferably have a size of from 1 micron to 75 microns, more preferably from 5 microns to 30 microns. The microcapsule walls preferably have a thickness of from 0.05 microns to 10 microns, more preferably from 0.05 microns to 1 micron. Typically, the microcapsule core comprises from 50% to 95% by weight of the benefit agent.

The liquid composition may optionally comprise a suspended insoluble fluid. Suitable insoluble fluids include silicones, perfume oils, and the like. Perfume oils provide an odour benefit to the liquid composition, or to substrates treated with the liquid composition. When added, such perfumes are added at a level of from 0.1% to 5%, more preferably from 0.3% to 3%, even more preferably from 0.6% to 2% by weight of the liquid fabric care composition. Suitable silicones include silicones which provide a fabric care benefit, such as fabric softening, and ease of ironing. For improved fabric care, the silicones can be functionalised.

Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from 10 to 2,000,000 centistokes at 25° C. In another aspect, suitable organosilicones may have a viscosity of from 10 to 800,000 centistokes at 25° C.

Suitable functionalised silicones can be selected from the group consisting of: organosilicones, silicone-based quaternary ammonium compounds, silicone polyethers, aminosilicones, and combinations thereof.

Suitable organosilicones may be linear, branched or cross-linked. In one aspect, the organosilicones may comprise of silicone resins. Silicone resins are highly cross-linked polymeric siloxane systems. The cross-linking is introduced through the incorporation of trifunctional and tetrafunctional silanes with monofunctional or difunctional, or both, silanes during manufacture of the silicone resin.

Other modified silicones or silicone copolymers are also useful herein. Examples of these include silicone-based quaternary ammonium compounds (Kennan quats) disclosed in U.S. Pat. Nos. 6,607,717 and 6,482,969; end-terminal quaternary siloxanes; silicone aminopolyalkyleneoxide block copolymers disclosed in U.S. Pat. Nos. 5,807,956 and 5,981,681; hydrophilic silicone emulsions disclosed in U.S. Pat. No. 6,207,782; and polymers made up of one or more crosslinked rake or comb silicone copolymer segments disclosed in U.S. Pat. No. 7,465,439. Additional modified silicones or silicone copolymers useful herein are described in US Patent Application Nos. 2007/0286837A1 and 2005/0048549A1.

In alternative embodiments of the liquid fabric care compositions of the present invention, the above-noted silicone-based quaternary ammonium compounds may be combined with the silicone polymers described in U.S. Pat. Nos 7,041,767 and 7,217,777 and US Application number 2007/0041929A1.

Suitable silicones include organosilicones. The organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the names DC 200 Fluid, DC 1664, DC 349, DC 346G available from Dow Corning® Corporation, Midland, Mich., and those available under the trade names SF1202, SF1204, SF96, and Viscasil® available from Momentive Silicones, Waterford, N.Y.

The organosilicone may be a cyclic silicone. The cyclic silicone may comprise a cyclomethicone of the formula [(CH₃)₂SiO]ₙ where n is an integer that may range from about 3 to about 7, or from about 5 to about 6.

The organosilicone may be a functionalized siloxane polymer. Functionalized siloxane polymers comprise one or more functional moieties, preferably selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

Suitable functionalised silicones include silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning® Corporation, and various Silwet® surfactants available from Momentive Silicones.

The functionalized silicone may be an aminosilicone. Suitable aminosilicones are described in U.S. Pat. Nos. 7,335,630 B2, 4,911,852, and USPA 2005/0170994A1.

Microfibrillated cellulose, derived vegetables or wood, particularly from sugar beet or chicory root are effective at preventing the segregation of water-soluble polymers, and any resultant phase separation of the liquid composition. Hence, the liquid composition of the present invention may comprise a water-soluble polymer. Water soluble are soluble or dispersible to at least the extent of 0.01% by weight in distilled water at 25° C. The liquid fabric care composition may comprise one or more water soluble polymers.

Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Those of ordinary skill in the art will recognize that additional additives are optional but are often used in liquid fabric care compositions. Suitable additional additives include ingredients selected from the group comprising, additional softener actives, silicone compounds, structurants, deposition aids, perfumes, benefit agent delivery systems, dispersing agents, stabilizers, pH control agents, colorants, brighteners, dyes, odor control agent, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners, chelants, electrolytes and mixtures thereof. Such additives are known and can be included in the present formulation as needed.

Suitable electrolytes for use in the liquid fabric care compositions include alkali metal and alkaline earth metal salts such as those derived from potassium, sodium, calcium, magnesium.

Process for Making the Liquid Fabric Care Composition:

The microfibrillated cellulose, derived from vegetables or wood, can be added into a liquid fabric care composition using any suitable means. For instance, the liquid fabric care composition can be manufactured using a process comprising the steps of: providing a structuring premix comprising microfibrillated cellulose, derived from vegetables or wood; providing a fabric care premix comprising a fabric softener active; incorporating the structuring premix into the liquid fabric care premix using high shear mixing. Any suitable means of high shear mixing can be used, including the use of either continuous and non continuous high shear mixers. High shear mixing can be provided via a dynamic mixer or static mixer.

The structuring premix typically comprises a slurry of the microfibrillated cellulose, derived from vegetables or wood, more preferably derived from sugar beet or chicory root. The structuring premix may comprise surfactant. Suitable surfactants may be selected from the group consisting of: anionic surfactant, nonionic surfactant, cationic surfactant, and mixtures thereof. However, if a surfactant is present, the structuring premix preferably comprises a nonionic surfactant.

For processes for manufacturing low water liquid compositions, the structuring premix may comprise non-aminofunctional solvent, such as propanediol. The addition of a non-aminofunctional solvent to the structuring premix improves the dispersion of the structuring premix into a low water liquid premix, which can comprise water at a level of less than 20%, preferably less than 15%, more preferably less than 10% by weight of the resultant liquid composition.

The liquid fabric care premix comprises a fabric softener active (FSA). The liquid premix typically comprises further ingredients, typically including all the ingredients that require high shear mixing. The liquid fabric care premix may be made by a process using an apparatus for mixing the components by producing shear, turbulence and/or cavitation. It should be understood that, in certain aspects, the ability of the process to induce shear may not only be useful for mixing, but may also be useful for dispersion of solid particles in liquids, liquid in liquid dispersions and in breaking up solid particles. In certain aspects, the ability of the process to induce shear and/or produce cavitation may also be useful for droplet and/or vesicle formation.

The fabric softener active is typically added as a melt, to an aqueous base mixture which is at a temperature which is sufficient for the fabric softener active to form vesicles. Hence, the fabric softener active is typically added at a temperature of above 40 C, preferably above 45 C, but not above the temperature at which the fabric softener active significantly degrades.

Shearing energy of from 10 g/cm s² to 1,000,000 g/cm s², from 50 g/cm s² to 500,000 g/cm s² from 100 g/cm s² to 100,000 g/cm s² is typically applied, for a residence time from 0.1 seconds to 10 minutes, from 1 second to 1 minute, from 2 seconds to 30 seconds is applied, in order to blend the components, and to ensure that the fabric softener active is sufficiently dispersed.

The liquid fabric care premix can then be cooled during and/or after said shearing step, to temperatures from 5° C. to 45° C., from 10° C. to 35° C., from 15° C. to 30° C., from 20° C. to 25° C.

One or more electrolyte, or adjunct ingredient can be added to the liquid fabric care premix, under shear.

Preferably, the structuring premix of the microfibrillated cellulose is the last ingredient incorporated into the liquid composition. The structuring premix is preferably incorporated into the liquid composition using high shear mixing. Preferably, the structuring premix is incorporated into the liquid composition using average shear rates of greater than 100 s⁻¹, preferably from 200 s⁻¹ to 25,000 s⁻¹, more preferably from 500 s⁻¹ to 10,000 s⁻¹. The residence time of mixing is preferably less than 60, more preferably less than 25 s, more preferably less than 5 s.

The shear rate and residence time is calculated according to the methods used for the mixing device, and is usually provided by the manufacturer. For instance, for a static mixer, the average shear rate is calculated using the equation:

$$\dot{γ} = \frac{{v}_{pipe}}{{D}_{pipe}} * {v}_{f}^{- 3 / 2}$$

where:
v_{f} is the void fraction of the static mixer (provided by the supplier)
Dₚᵢₚₑ is the internal diameter of the pipe comprising the static mixer elements
vₚᵢₚₑ is the average velocity of the fluid through a pipe having internal diameter Dₚᵢₚₑ, calculated from the equation:

$${v}_{pipe} = \frac{4 Q}{π {D}_{pipe}^{2}}$$

Q is the volume flow rate of the fluid through the static mixer.

For a static mixer, the residence time is calculated using the equation:

$$residence time = \frac{π {D}_{pipe}^{2} {v}_{f} L}{4 Q}$$

where:
L is the length of the static mixer.

Methods:

Method of Measuring Aspect Ratio of Microfibrillated Fibres:

The liquid fabric care composition or structuring premix is analysed using Atomic force microscopy (AFM). The sample was prepared using the following procedure: The single side polished Si wafer (<100>, 381 micron thickness, 2 nm native oxide, sourced from IDB Technologies, UK) is first cracked or cut into a piece of approximate dimensions 20×20 mm The liquid fabric care composition or premix is applied liberally to the Si wafer, using a cotton bud (Johnson & Johnson, UK). The coated wafer is placed into a lidded poly(styrene) Petri dish (40 mm diameter, 10 mm height, Fisher Scientific, UK) and left for 20 minutes in air under ambient conditions (18° C., 40-50% RH). The Petri dish is then filled with H₂O (HPLC grade, Sigma-Aldrich, UK) and the sample is left in the immersed conditions for approximately 20 minutes. Following this, a cotton bud is used to remove the composition or premix which has floated up away from the Si wafer surface, whilst the Si wafer was still immersed under HPLC grade H₂O. The Si wafer is then removed from the Petri dish and rinsed with HPLC grade H₂O. Subsequently, the Si wafer is dried in a fan oven at 35° C. for 10 min.

The wafer surface is then imaged as follows: The Si wafer is mounted in an AFM (NanoWizard II, JPK Instruments) and imaged in air under ambient conditions (18° C., 40-50% RH) using a rectangular Si cantilever with pyramidal tip (PPP-NCL, Windsor Scientific, UK) in Intermittent Contact Mode. The image dimensions are 40 micron by 40 micron, image height scale is set to 50 nm or less, the pixel density is set to 1024×1024, and the scan rate is set to 0.3 Hz, which corresponded to a tip velocity of 12 micron/s.

The resultant AFM image is analysed as follows: The AFM image is opened using ImageJ, version 1.46 (National Institute of Health, downloadable from: http://rsb.info nih gov/ij/). In the

“Analyze” menu, the scale is set to the actual image size in microns, 40 μm by 40 μm. 10 fibres, which do not contact the image edge, are selected at random. Using the “freehand line” function from the ImageJ Tools menu, the selected fibres are each traced, and the length (l) and cross dimension (d) are measured (menu selections: “Plugins”/“Analyze”/“Measure and Set Label”/“Length”), and averaged across the 10 samples.

Three sets of measurements (sample preparation, AFM measurement and image analysis) are made, the results averaged.

Method of Measuring the Viscosity of the Liquid Composition:

Unless otherwise specified, the viscosity is measured using an TA instrument AR G2 rheometer (Ta Instruments US), with a cone and plate geometry having an angle of 2°, and a gap of 40 microns. The shear rate is held constant at a shear rate of 0.01 s-1, until steady state is achieved, then the viscosity is measured. The shear rate is then measured at different shear rates from 0.1 to 1000 sec-1 doing an upward shear rate sweep in 5 minutes all measurements are made at 20° C.

Method of Measuring the Yield Stress of the Liquid Fabric Care Composition:

The yield stress is measured using an TA instrument AR G2 rheometer (Ta Instruments US), with a cone and plate geometry having an angle of 2°, and a gap of 40 microns. A downward equilibrium shear rate sweep of from 10 s⁻¹ to 0.01 s⁻¹ is applied at 20° C., and fitted to the Herschley Buckley model: τ=τ₀+Kγⁿ, where i is the shear stress, τ₀ to is the yield stress, and is γ the shear rate. K and n are fitting parameters.

Method for the Determination of Soluble, Insoluble and Total Dietary Fiber:

The method for the determination of soluble, insoluble and total dietary fibre is described in McCleary et al.: Journal of AOAC International Vol. 95, No. 3, 2012. Determination of Insoluble, Soluble, and Total Dietary Fiber (CODEX Definition) by Enzymatic-Gravimetric Method and Liquid Chromatography: Collaborative Study.

### EXAMPLES

Liquid fabric care compositions A and B, according to the present invention, were prepared as follows:

Chicory root fibres were extracted using the procedure described in U.S. Pat. No. 5,964,983, resulting in an aqueous premix of 6% by weight of microfibrillated cellulose derived from chicory root. The remaining ingredients were formed into a liquid fabric care premix, using the method described above. The premix comprising the microfibrillated cellulose derived from chicory root, was then added using a ULTRA TURRAX high shear mixer, operating at 13.500 rpm for 1 min, to achieve a homogeneous dispersion of the microfibrillated cellulose, derived from chicory root.

Comparative liquid fabric care compositions C and D, comprising Rheovis CDE® (a cationic acrylic polymer) as the external structurant, was prepared as follows:

All the ingredients, except for the external structurant, were formed into a liquid fabric care premix, using the method described above. A Ytron-Y in-line mixer, at 25 Hz, was then used to blend the Rheovis CDE® external structurant into the liquid fabric care premix, to form the finished liquid fabric care composition.

TABLE 1
Liquid fabric care compositions A and B, of the present
invention, comprise microfibrillated cellulose derived
from chicory root. Comparative liquid compositions C and
D comprise Rheovis CDE ® as the external structurant:

| | % w/w in liquid fabric | | | |
|---|---|---|---|---|
| | care composition | | | |
| Component | A | B | C* | D* |
| DEEDMAC¹ | 9.65 | 9.40 | 9.90 | 9.89 |
| Isopropanol | 0.95 | 0.92 | 0.97 | 0.97 |
| Formic Acid | 0.02 | 0.02 | 0.02 | 0.02 |
| HCl | 0.01 | 0.01 | 0.01 | 0.01 |
| CaCl₂ | 0.02 | 0.02 | 0.02 | 0.02 |
| Minors (chelant, preservative) | 0.01 | 0.01 | 0.01 | 0.01 |
| Silicone | 1.21 | 1.21 | 1.21 | 1.21 |
| Perfume Microcapsule | 0.40 | 0.40 | 0.40 | 0.40 |
| Dye | 0.20 | 0.20 | 0.20 | 0.20 |
| Neat Unencapsulated Perfume | 0.54 | 0.54 | 0.54 | 0.54 |
| Microfibrillated cellulose | 0.15 | 0.30 | — | — |
| derived from chicory root | | | | |
| Rheovis CDE | — | — | 0.07 | 0.14 |
| Deionized water | Up to | Up to | Up to | Up to |
| | 100 | 100 | 100 | 100 |
| Viscosity after making (20° C.): | 4.26 | 23.69 | 5.44 | 26.13 |
| at 0.01 s⁻¹ | | | | |
| Viscosity after making (20° C.): | 0.28 | 0.77 | 0.39 | 0.98 |
| at 1 s⁻¹ | | | | |
| Viscosity after making (20° C.): | 0.04 | 0.06 | 0.05 | 0.08 |
| at 100 s⁻¹ | | | | |
| Viscosity after 1 week at (20° C.): | 5.08 | 17.61 | 6.57 | 28.26 |
| at 0.01 s⁻¹ | | | | |
| Viscosity after 5 weeks at (20° C.): | 5.43 | 16.89 | 9.29 | 26.85 |
| at 0.01 s⁻¹ | | | | |
| Viscosity after 1 cycle of 50° C. | 5.28 | 18.94 | 3.91 | 7.22 |
| for 4 days, and 25° C. for 3 days: | | | | |
| at 0.01 s⁻¹ | | | | |
| Viscosity after 4 cycles of 50° C. | 4.90 | 20.59 | 1.36 | 2.76 |
| for 4 days, and 25° C. for 3 days): | | | | |
| at 0.01 s⁻¹ | | | | |

*Comparative
¹diethyl-ester-dimethyl-ammonium-chloride

The liquid fabric care compositions, A and B, comprising microfibrillated cellulose derived from chicory root, as the external structurant, have a yield stress and low shear viscosity which is sufficient to stabilise the microcapsules.

In addition, the viscosity profile of the fabric care compositions remain stable at 20° C., even after 5 weeks. Moreover, the viscosity profile of the liquid fabric care compositions remain stable, even after 5 cycles of 4 days at 50° C. followed by 3 days at 25° C.

In contrast, the viscosity of comparative compositions C and D is reduced sharply, after even 1 cycle of 4 days at 50° C. followed by 3 days at 25° C.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A liquid fabric care composition comprising:
a) fabric softener active,
b) microfibrillated cellulose derived from wood, wherein the microfibrillated cellulose has an aspect ratio (l/d) of from about 50 to about 200,000, and
c) suspended insoluble material comprising microcapsules, said microcapsules having a size of from 1 micron to 75 microns.

2. The composition according to claim 1 wherein said fabric softener active is selected from the group consisting of di-tail fabric softener actives, mono-tail fabric softener actives, ion pair fabric softener actives and mixtures thereof.

3. The composition according to claim 1, wherein the composition comprises, based on total composition weight, at least about 1%of the fabric softener active or mixture of fabric softener actives.

4. The composition according to claim 1, wherein the composition comprises less than 90% of the fabric softener active or mixture of fabric softener actives.

5. (canceled)

6. The composition according to claim 1, wherein the microfibrillated cellulose is derived from wood, wherein the wood comprises less than about 10% soluble fibre as a percentage of total fibre.

7. (canceled)

8. The composition according to claim 1, wherein the composition comprises from about 0.05 to about 10 wt % of the microfibrillated cellulose.

9. The composition according to claim 1, wherein the composition comprises sufficient microfibrillated cellulose to provide a yield stress of greater than about 0.05 Pa.

10. (canceled)

11. The composition according to claim 1, wherein the suspended insoluble material further comprises insoluble fluids.

12. (canceled)

13. (canceled)

14. A process to manufacture a liquid composition comprising a surfactant and microfibrillated cellulose derived from vegetables or wood, the process comprising the steps of:
a) providing a structuring premix comprising microfibrillated cellulose derived from vegetables or wood;
b) providing a fabric care premix comprising a fabric softener active; and
c) incorporating the structuring premix into the liquid fabric care premix using high shear mixing.

15. The composition according to claim 1, wherein the microcapsules are perfume encapsulates.

16. The composition according to claim 1, wherein the microcapsules comprise a microcapsule core and a microcapsule wall that surrounds the microcapsule core.

17. The composition according to claim 16, wherein the microcapsule wall is formed by cross-linking formaldehyde with at least one other monomer.

18. The composition according to claim 16, wherein the microcapsule core comprises perfume.

19. The composition according to claim 16, wherein the microcapsule core comprises a diluent.

20. The composition according to claim 19, wherein the diluent is selected from the group consisting of isopropylmyristate, propylene glycol, poly(ethylene glycol), or mixtures thereof.
